(19) United States
(12) Patent Application Publication
(10) Pub. No.: US 2007/0177670 A1
(43) Pub. Date: Aug. 2, 2007

(54) Use of Pilot Symbols for Data Transmission in Uncompressed, Wireless Transmission of Video

(76) Inventors: Nathan Elnathan, Ran'anna (IL); Meir Feder, Herzliya (IL); Zvi Reznic, Tel Aviv (IL)

Correspondence Address: GLENN PATENT GROUP, 3475 EDISON WAY, SUITE L, MENLO PARK, CA, 94025, US

(21) Appl. No.: 11/621,919

(22) Filed: Jan. 10, 2007

Related U.S. Application Data
(60) Provisional application No. 60/758,060, filed on Jan. 10, 2006.

(51) Int. Cl. H04N 11/04; H04N 7/12

(52) U.S. Cl. 375/240.18; 375/240.26

(57) ABSTRACT

The uncompressed wireless transmission of video, as with many other wireless applications, requires constant knowledge of channel characteristics at the receiver end. To estimate the channel and track its changes, pilots containing known data are sent in various parts of the used bandwidth. The use of such pilots reduces the effective bandwidth available for data transmission. Due to the relative high immunity to introduced interference of certain transmission modes, such as QPSK and QAM, pilots can be modulated by digital data components. At the receiver, pilots are demodulated and used for a decision-directed circuit to determine the characteristics of the transmission channel. The additional bandwidth allows a higher data rate which may be such used for various purposes as diversity, coding, etc. Such use of pilot signals is of particular advantage in the wireless transmission of the DC and near DC components of essentially uncompressed video.

### CROSS REFERENCE TO RELATED APPLICATIONS

This application claims priority from U.S. Provisional Patent Application No. 60/758,060 filed on Jan. 10, 2006 which is incorporated herewith in its entirety by the reference thereto.

### BACKGROUND OF THE INVENTION

1. Field of the Invention

The invention relates to the use of pilot symbols in the transmission of uncompressed video over a wireless link. More specifically, the invention relates to use of pilots to transmit data symbols in video transmission where direct mapping of image transform coefficients to transmission symbols is performed.

2. Discussion of the Prior Art

In many houses, television and/or video signals are received through cable or satellite links at a set-top box that is located at a fixed point in the house. In many cases, it is desired to place a screen at a point a distance from the set-top box by a few meters. This trend is becoming more common as flat-screen using plasma or liquid crystal display (LCD) televisions are increasingly hung on a wall. Connection of the screen to the set-top box through cables is generally undesired for aesthetic reasons and/or installation convenience. Thus, wireless transmission of the video signals from the set-top box to the screen is preferred. Similarly, it may be desired to place a computer, game controller, VCR, DVD, or other video source that generates images to be displayed on a screen a distance from the screen.

Generally, the data received at the set-top box are compressed in accordance, for example, with the motion picture expert group (MPEG) format and are decompressed by the set-top box to a high quality raw video signal. The raw video signal may be in an analog format or a digital format, such as the digital video interface (DVI) format or the high definition multimedia interface (HDMI) format. These digital formats generally have a high definition television (HDTV) data rate of up to about 1.5 Giga bits per second (Gbps).

Wireless short range transmission in the home can be accomplished over the unlicensed bands around 2.4 GHz or around 5 GHz, e.g. in the U.S in the 5.15-5.85 GHz band. These bands are currently used by wireless local area networks (WLAN), where the 802.11 WiFi standard allows maximal data rates of 11 Mbps (802.11b), or 54 Mbps for 20 MHz bandwidth using the 802.11g/802.11a standards. With the emerging Multi-Input Multi-Output technology the data rate of the 802.11n standard is increased to around 200 Mbps. Another alternative is to use Ultra Wide Band (UWB), which claims to provide 100-400 Mbps.

Because the available data rate is lower than the 1.5 Gbps needed for uncompressed HDTV video, the video generally must be recompressed for wireless transmission, when desired. Known strong video compression methods, e.g. those having a compression factor of above 1:30, require very complex hardware to implement the compression. This is generally not practical for home applications. These compression methods generally transform the image into a different domain by using, for example, wavelet, discrete cosine transform (DCT), or Fourier transforms, and then perform the compression in that domain. In PCT application IL/2004/000779, Wireless Transmission of High Quality Video, assigned to common assignee and incorporated herein in its entirety by this reference thereto, there is discussed a method of transmitting video images. The method includes providing high definition video, compressing the video using an image domain compression method in which each pixel is coded based on a vicinity of the pixel, and transmitting the compressed video over a fading transmission channel.

U.S. patent publication 2003/002582 by Obrador describes wireless transmission of images which are encoded using joint source channel coding (JSCC). The transmitted images are decomposed into a plurality of sub-bands of different frequencies. Image and corresponding boundary coefficients with a lowest resolution are sent first, and then image and boundary coefficients with a higher resolution are transmitted. An exemplary JSCC applies channel encoding techniques to the source coded coefficients, providing more protection to more important, i.e. low frequency, coefficients and less protection to less important, i.e. high frequency, coefficients.

In digital transmission methods, signals are transmitted in the form of symbols. Each symbol can have one of a predetermined number of possible values. The set of possible values of each symbol is referred to as a constellation and each possible value is referred to as a bin. In two dimensional constellations, the distance between neighboring bins affects the immunity of the symbols to noise. The noise causes reception of the symbol in a bin that may not be the intended bin. If, due to the noise, the symbol is closer to a different bin than intended, the symbol may be interpreted incorrectly. See Ramstad, The Marriage of Subband Coding and OFDM Transmission, Norwegian University of Science and Technology (July 2003).

In U.S. patent application serial nos. 2004/0196920 and 2004/0196404 by Loheit et al. another scheme is proposed for the transmission of HDTV over a wireless link. The discussed scheme transmits and receives an uncompressed HDTV signal over a wireless RF link which includes a clock that provides a clock signal which is synchronized to the uncompressed HDTV signal. This scheme also includes a data regeneration module that is connected to the clock, and which provides a stream of regenerated data from the uncompressed HDTV signal. A demultiplexer demultiplexes the stream of regenerated data using the clock signal into an I data stream and a Q data stream. A modulator connected to the demultiplexer modulates a carrier with the I data stream and the Q data stream. According to Loheit et al., the RF links operate at a variety of frequency bands from 18 GHz up to 110 GHz, hence requiring sophisticated and more expensive transmitters and receivers.

To provide better reception, pilot symbols are used in OFDM transmission. The pilot symbols are used for the purpose of enabling synchronization of the reception to the channel characteristics, thereby enabling a better and more accurate reception of the transmitted data. This is of particular importance in systems where retransmission of data is not possible, for example in the case of a bandwidth limited channel, such as is typically found where there is a need to transmit HDTV signals over a wireless link. However, the use of the pilot signals that are known to both the transmitter and the receiver reduces the effective bandwidth because fewer symbols are made available for transmission of actual data. A training session may therefore be used periodically to attempt to overcome this limitation. Nonetheless, this is still a restriction on the performance of the channel. Moreover, this scheme does not overcome drift in channel characteristics in real-time.

In view of a variety of limitations of the prior art, it would be therefore advantageous to provide a solution that enables the reliable wireless transmission of an HDTV stream, while avoiding the need to dedicate a portion of the available bandwidth to the transmission of known data solely for the purpose of pilot symbols.

### SUMMARY OF THE INVENTION

The uncompressed wireless transmission of video, as with many other wireless applications, requires constant knowledge of channel characteristics at the receiver end. To estimate the channel and track its changes, pilots containing known data are sent in various parts of the used bandwidth. The use of such pilots reduces the effective bandwidth available for data transmission. Due to the relative high immunity to introduced interference of certain transmission modes, such as QPSK and QAM, pilots can be modulated by digital data components. At the receiver, pilots are demodulated and used for a decision-directed circuit to determine the characteristics of the transmission channel. The additional bandwidth allows a higher data rate which may be such used for various purposes as diversity, coding, etc. Such use of pilot signals is of particular advantage in the wireless transmission of the DC and near DC components of essentially uncompressed video.

### BRIEF DESCRIPTION OF THE FIGURES

FIG. 1 is a block diagram of coding system in accordance with the invention;

FIG. 2 is a schematic diagram showing an 8-by-8 pixel de-correlation transform, the grouping of the coefficients, and the mapping into digital and analog symbols in accordance with the invention;

FIG. 3 is a table showing the number of coefficients selected from each of the transformed Y, Cr, and Cb of an 8-by-8 pixel conversion in accordance with the invention;

FIG. 4 is a flow diagram showing handling an HDTV video for wireless transmission using—an OFDM scheme in accordance with the invention;

FIG. 5 is a detailed block diagram of a coding system in accordance with the invention;

FIG. 6 is a block diagram of the bit manipulation block of a coding system in accordance with the invention; and

FIG. 7 is a flowchart of a method for using pilots to transmit data symbols in a modified decision-directed transceiver in accordance with the invention.

### DETAILED DESCRIPTION OF THE PREFERRED EMBODIMENTS

The uncompressed wireless transmission of video, as with many other wireless applications, requires the constant knowledge of the channel characteristics at the receiver. To estimate the channel and track its changes, pilots containing known data are sent in various parts of the used bandwidth. The use of such pilots reduces the effective bandwidth available for data transmission. Due to the relative high immunity to introduced interference of certain transmission modes, such as QPSK and QAM, pilots can be modulated by digital data components. At the receiver, pilots are demodulated and used by a decision-directed circuit to determine the characteristics of the transmission channel. The additional bandwidth allows higher a data rate that can be used for various purposes, such as diversity, coding, etc. Such use of pilot signals is of particular advantage in the wireless transmission of the DC and near DC components of essentially uncompressed video. See, for example, U.S. patent application entitled: Apparatus and Method for Uncompressed, Wireless Transmission of Video, Ser. No. 11/551,641, is incorporated herein in its entirety by this reference thereto.

The invention disclosed herein is better understood with respect to a video transmission system enabling the mapping the coefficients of a block of pixels after a de-correlating transformation, or a portion thereof, directly into the transmission symbols. Preferably, a discrete cosine transform (DCT) is performed on a block of pixels of each of the Y, Cr, and Cb components of a video signal. The Y component provides the luminance of the pixel, while the Cr and Cb components provide the color difference information. In a preferred embodiment of the invention, only a portion of the coefficients are used for transmission purposes, avoiding the very high frequency coefficients while keeping the lower frequency coefficients. Significantly, more of the Y related coefficients are preserved for wireless transmission purposes than those for the other two components. For example, a ratio of at least three coefficients of the Y component may be used for each of the Cr and Cb components, e.g. a ratio of 3:1:1. DC coefficients, or proximate coefficients having a larger value, are also represented in a digital manner, i.e. part of the DC value is represented as one of a plurality of constellation points of a symbol. The higher frequency coefficients and, in addition, the quantization errors of the DC and the proximate components whose main part is presented digitally are grouped in pairs, positioning each pair in a symbol as the real and imaginary values of the complex number. Optionally, a possibly non-linear transformation of these values is represented as a complex number of that mapped to an OFDM component.

Following is a detailed description of the operation of the invention. While the invention is described with respect to particular embodiments and respective figures, such are not intended to limit the scope of the invention and are provided for purposes of example only.

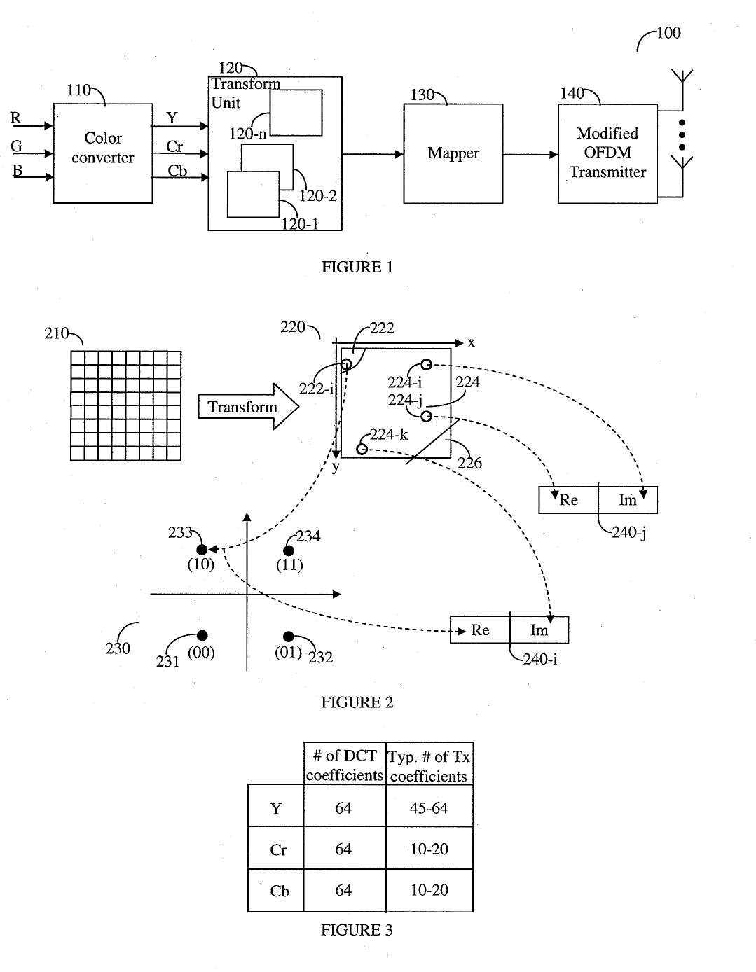

FIG. 1 is a block diagram of system 100 for direct symbol coding in accordance with the invention. The system 100 receives the red-green-blue (RGB) components of a video signal, for example an HDTV video signal. The RGB stream is converted in the color conversion block 110 to the luminance component Y, and the two color difference components, Cr and Cb. This conversion is well known to persons of ordinary skill in the art. In one embodiment of the invention, the video begins with a Y-Cr-Cb video signal and, in such a case, there is no need for the color conversion block 110. The Y-Cr-Cb components are fed to a transform unit 120 where a de-correlating transformation is performed on blocks of pixels of each of the three components.

In one embodiment of the invention, the block 120 performs a DCT on the blocks of pixels. A block of pixels may contain 64 pixels arranged in an 8-by-8 format, as shown in to FIG. 2. The transform unit 120 may comprise a single subunit for performing the desired transform, for example a DCT, and for handling the conversions for all the blocks of pixels of an entire video frame for each of the Y-Cr-Cb components. In another embodiment, a dedicated transform subunit is used for each of the Y-Cr-Cb components, thereby accelerating the performance of the system. In yet another embodiment a plurality of subunits are used, such that two or more such subunits, capable of performing a desired transform on a block of pixels, are used for each of the Y-Cr-Cb components, thus further accelerating the performance of the system 100.

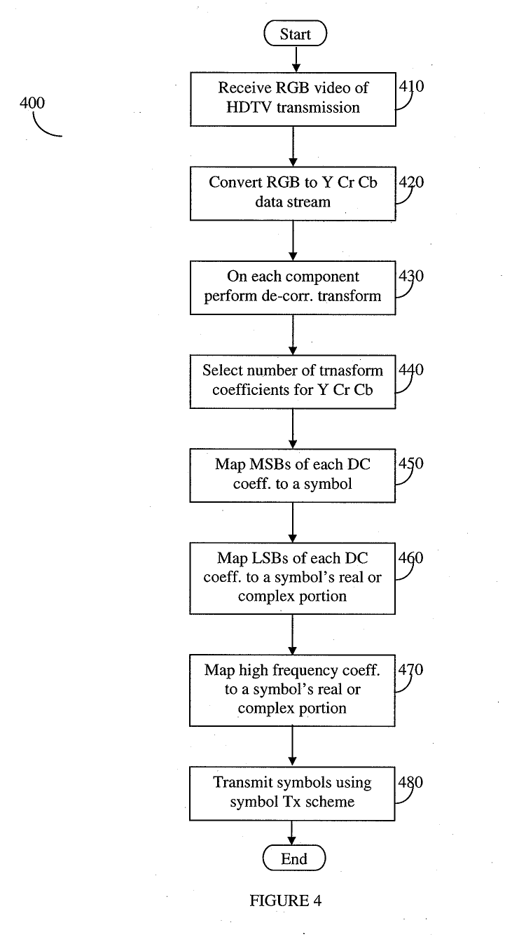

The output of transform unit 120 is a series of coefficients which are fed to a mapper 130. The mapper 130 selects those coefficients from each of the Y-Cr-Cb components which are to be transferred over the wireless link. The mapper 130 also maps the coefficients to be sent to transmission symbols, for example, the symbols of an orthogonal frequency division multiplexing (OFDM) scheme. This process is described in more detail with respect to FIG. 4. The symbols are then transmitted using a modified OFDM transmitter 140 that handles symbols having a mix of digital and analog values, as explained in more detail with respect to FIG. 2.

In one embodiment of the invention, a modified OFDM transmitter 140 is connected to a plurality of antennas for the purpose of supporting a multi-input, multi-output (MIMO) transmission scheme, thereby increasing bandwidth and reliability of the transmission. A person skilled in the art would further appreciate that a receiver adapted to receive the wireless signal comprising the symbols transmitted in accordance with the invention must be capable of detecting the digital and analog symbols, reconstructing the respective coefficients, and performing an inverse transform to reconstruct the Y-Cr-Cb components. However, because there is no frame-to-frame compression, there is no need for frame buffers in the system. Because the mapping and transform are fast and work on small blocks with no need to consider neither wide area correlation in the image nor frame-to-frame correlations, there is practically no delay associated with the operations disclosed herein.

In accordance with the invention, a de-correlating transform, such as a DCT, is performed on blocks of pixels, for example 8-by-8 pixels, on each of the Y-Cr-Cb components of the video. As a result of the transform on a block, for example a block 210 shown in FIG. 2, a two-dimensional coefficient matrix 220 is created. The coefficients closer to the origin in the area 222 are generally the low frequency and DC portions of each of the Y-Cr-Cb components, such as the coefficient 222-i. Higher frequency coefficients that may be found in the area 224, such as coefficients 224-i, 224-j, and 224-k, generally have a significantly smaller magnitude than the DC components, for example less than half the amplitude of the DC component. Even higher frequencies may be found in the area marked as 226. To keep an essentially uncompressed video, it is possible to remove the high frequency coefficients in the area 226 for each of the Y-Cr-Cb components. The area 226 may be smaller or larger depending on the number of coefficients that may be sent in a particular implementation. The main portion of the DC coefficient, for example the most significant bits of the coefficient 222-i, is preferably mapped into one of a plurality of constellation points, such as shown in the constellation map 230. A constellation map may be a 4QAM (QPSK), 16QAM, or any other appropriate type. Because four constellation points 231 through 234 are shown in constellation map 230, a 4QAM implementation is taught in this embodiment, and each of the constellation points is mapped to a digital value from 00 to 11, respectively.

The coefficient 222-i is mapped to one such constellation point, depending on its specific value. However, it is also likely to have a quantization error, or in other words, a value corresponding to the difference between the original value and the value represented by the digital bits that are mapped to constellation points. This error essentially corresponds to the least significant bits of the coefficient's value. Such a mapping is considered a digital value mapping. The quantization error value may be mapped as part of the symbol 240-i as, for example, the real portion of the complex number constituting the symbol 240-i. The higher frequency coefficients are paired and each pair is mapped as a real portion and an imaginary portion of a complex number. For example, the coefficients 224-i and 224-j may be mapped to the imaginary and real portions of a symbol 240-j. As noted above, a receiver enabled to receive the symbol stream disclosed herein should be able to recompose the coefficients from the values provided. Such a mapping is considered an analog value mapping. It should be noted that the transferred data may be coded or uncoded.

An exemplary reference may be found in FIG. 3, where an 8-by-8 coefficient matrix is assumed and, hence, there are 64 coefficients found for each of the Y-Cr-Cb components. However, for the reasons mentioned hereinabove, typically between 28-64 of the coefficients of the Y component, and 6-20 of each of the Cr and Cb components are transmitted over the wireless link. The exact number of coefficients may be determined based on the available number of OFDM symbols available for wireless transmission and the desired level of reliability of the wireless transmission. In a typical transmission of HDTV video, a single frame is contained in about 1200 OFDM symbols, which are about 14,400 blocks of 8-by-8 pixels.

FIG. 4 shows where an exemplary and non-limiting flow 400 of the handling of an HDTV video signal for wireless transmission using the OFDM scheme in accordance with the invention. In step 410, a RGB video is received. In step 420, the RGB is converted to a Y-Cr-Cb video data stream. In one embodiment of the invention, a Y-Cr-Cb video is provided and, therefore, the conversions discussed with respect to steps 410 and 420 are not necessary. In step 430, a de-correlating transform is performed, for example a DCT, on each of the plurality of blocks of pixels, for example a block of 8-by-8 pixels, of each of the Y-Cr-Cb components of the video. A plurality of coefficients is created as a result for each block, for example 64 coefficients in the case of the 8-by-8 block. In step 440, for each of the Y-Cr-Cb components, the number of coefficients to be transmitted is selected. A person skilled in the art would appreciate that, in a sense, an analog compression or more accurately, compaction, takes place in this case. However, the compaction takes place on very low analog values.

Steps 450 through 470 provide a more detailed description of the mapping process discussed with respect to FIGS. 1 and 2 above. In step 450, the coefficients in the DC range are handled. Typically, their amplitude is significantly higher than that of the rest of the coefficients, i.e. their most significant bits (MSBs) are material for the information to be sent. Therefore, the MSBs of these coefficients are mapped separately and differently from their respective least significant bits (LSBs), which are otherwise referred to as the quantization error of the DC coefficient. For example, if the coefficient is represented by 11-bits, the three MSBs are separated from the rest of the bits and transferred as a symbol on its own. In one embodiment, the MSBs are repeated in several symbols for the purpose of ensuring proper and robust reception because the loss of these bits is significant for the quality of the reconstructed image. Specifically, these MSBs are sent as a digital value, as explained in more detail with respect to FIG. 2 above.

In another embodiment an error correction code is used to assure the robust reception of these bits. The LSBs of the DC component, as well as the rest of the coefficients that (as noted above) have an amplitude described by the LSBs, for example 8 LSBs of an 11-bit value, may be mapped, as explained with respect of steps 460 and 470, and as further discussed with reference to FIG. 2 above. Each pair of LSB values may be viewed as the real and imaginary components of a complex value which establishes a symbol of the OFDM scheme. Therefore, if there are 230 available symbols for transmission in a given time slot, it is possible to send up to 460 pairs of real and imaginary portions of a complex values. However, some 60 symbols are used to send digital values, as explained above. In step 480, the symbols are transmitted over a wireless link using the OFDM scheme. The overall result of using the steps described herein is to provide a very high frame rate, for example above 45 frames per second, or over 0.6 Gbits per second of video information, hence allowing for a high quality transmission of HDTV video where the video is essentially uncompressed.

The separation to MSB and LSB in describing the DC and other important transform coefficients can be generalized as follows: These coefficients can pass via a quantizer that can take several values, E−6 M=2ˆn. The specification of the quantizer value, represented by n bits, plays the role of the MSB's above, while the quantization error, i.e. the original value minus the value represented by the quantizer, plays the role of the LSB's above.

One embodiment of the invention makes use of pilots. Commonly, pilots are sent as a priori known signals in some bins of the OFDM symbol, preferably a value from a QPSK constellation. These pilots, alone or in conjunction with other pilots, are used in standard modems for synchronization, frequency, phase corrections, and the like. Pilots can also help in channel estimation and equalization. In standard digital modem, these pilots together with the digital information values, the latter being used via decision feedback because these values are known to those skilled in the art after decoding, allow robust channel estimation and tracking. Referring to FIG. 2, diagram 230 shows the four constellation points of a QPSK transmission, i.e. points 231, 232, 233, and 234. At the receiver end, the received point may be at the approximate location around the desired point, for example point 231. However, because of the sparseness of constellation points in the QPSK transmission scheme, it is relatively easy to identify a constellation point. Therefore, according to the invention, instead of the standard pilot symbols sent, there is made use of the nature of QPSK to have a dual function for certain pilots as both a pilot and a data carrier. A decision directed feedback mechanism allows the identification of the robust digital symbols sent in accordance with the system and, as they are sent in a QPSK modulation, identification of channel characteristics from these data modulated pilots. In effect, the number of standard pilots of prior art solutions can be reduced and additional modulated pilots are used for the purpose of channel estimation. The end result is a more accurate reception of the signal, providing a significant advantage by not requiring additional bandwidth for pilot symbols, while providing pilot signal capabilities for the system. A person skilled-in-the-art would note that the method disclosed herein is not limited to QPSK, and other transmission schemes, for example 16-QAM, may similarly benefit from the teachings of this invention. Furthermore, the disclosed invention allows for the reduction of the energy of the analog data and the securing of the important data using normal digital data transmission. More specifically, sensitive data transmitted using appropriate transmission schemes, for example QPSK or 16-QAM, that are used for the purpose of sending sensitive data, for example video or audio, may be used as pilot symbols as disclosed herein. Effectively, according to the disclosed method, there is achieved a better tracking of the transmission channel characteristics enabling the system in general and a receiver in particular, to be more resilient to channel interference.

Specifically, in the invention, the analog data sent in the manner discussed in more detail above, makes the use of decision feedback impossible. Therefore, in accordance with this embodiment of the invention additional pilots are sent to ensure stable channel estimation and tracking. These pilots are used for sending the digital data discussed in more detail above, i.e. MSBs of some transform coefficients are sent over these pilots. Because additional pilot signals are sent, there is more room for digital data. This results in an improved signal-to-noise ratio (SNR) on the analog data because even larger portion of the DCT coefficient is now sent digitally. In one embodiment of the invention approximately 30% of the sent data over the wireless channel is the digital portion, as explained above in more detail, and which may be used in accordance with the disclosed method for a decision directed correction of the received symbols using, for example, least mean square (LMS) techniques.

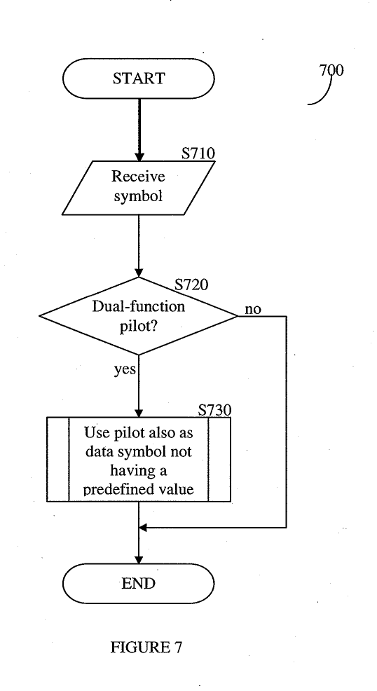

FIG. 7 is a flowchart 700 sharing a method for using pilots as data symbols in a modified decision-directed transceiver. In step S710, a symbol is received and, in step S720, it is determined if the symbol is a dual-function pilot. A dual-function pilot is a symbol received in a transmission scheme such as, but not limited to, QPSK or 16-QAM, and used for the sending of data as explained in more detail above. If the pilot is a dual-function pilot then execution continues with step S730. Otherwise, execution terminates, until another pilot is received when the method is repeated. In step S730, the dual-function pilot is used as a pilot signal not having a predetermined value. As explained in more detail above, in conjunction with FIG. 2 and diagram 230, the constellation point for the data, in for example a QPSK constellation scheme, can be determined to be in one of the four quadrants of diagram 230 and, therefore, determines the respective data. Therefore, it is considered as if known data had been sent that is in the specific quadrant of detection and, hence, that is associated with the appropriate symbol. For example, if the signal is found to be in the left upper quadrant then, regardless of its specific position, it is associated with the constellation point 233, i.e. a ‘10’. The decision directed correction system can now use the resulting channel characteristics derived from the necessary correction of this symbol for a more accurate reception of the other symbols to be received. The method is repeated with each symbol received.

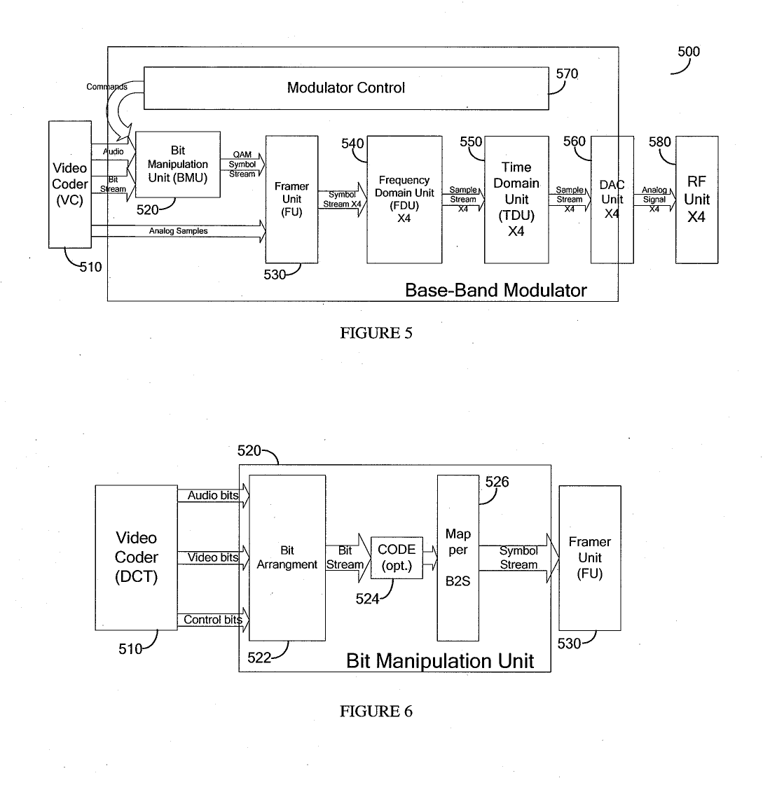

FIG. 5 is a block diagram 500 showing a system for handling the coding in accordance with the disclosed invention. A base band modulator is divided into five basic blocks according to the functionality and working domain of each bock. The modulator input consists of four signals: one signal is an analog symbol stream, the result of the transform discussed in more detail above with respect to the handling of the LSBs of the coefficients. Another signal is a digital bit stream that represents the DC values for Y, Cr, and Cb components, as explained in more detail above with respect of the MSBs of the coefficients. In addition, there may be an audio signal that may come from video coder 510, and a signal that comes from a modem control 570. This signal from the modem control 570 consists of a number of control commands that are to be passed to the receiver, as well as other control signals that are used to control the modulator. In one embodiment of the system 500, the modulator output consists of a plurality of identical signals, for example four signals that carry the information to digital-to-analog converter 560. This allows for the implementation of MIMO transmission, as discussed above.

FIG. 6 is a block diagram sharing a bit manipulation unit (BMU) 520 of the system 500. The BMU 520 is capable of performing all bit manipulations on the data bits themselves. No quantization errors are handled by the BMU 520, and all operations are performed bitwise.

First, three bit streams are arranged in a predefined order and create a single bit stream. After optional coding, the bits of the single bit stream are mapped to the desired constellation and passed to a framer unit 530. The framer unit 530 receives the data as a number of sample streams and organizes it into four sample streams with an appropriate header, pilots, and so on. Two different data streams are padded with pilots and, optionally, with some other data where it may be deemed necessary, and then interleaved.

In a MIMO implementation, the stream is divided into a plurality of streams, for example four streams, one for each of the MIMO transmitters. The frequency domain unit (FDU) 540 gets its inputs from the framer 530. The framer 530 creates a symbol stream, such that each symbol is a complex number, as described hereinabove, that represents a point in the two-dimensional space. The framer 530 also includes an IFFT operation, and the resultant signal is fed to the time domain unit (TDU) 550, where certain shaping of the signal is performed prior to converting the signal to an analog signal in the digital-to-analog converter (DAC) 560.

The DAC 560 may be operative, in one embodiment of the invention, at a sampling rate of 40 MHz, or even higher frequencies, for example 80 or 160 MHz. The desirable number of bits can be approximated using the following assumptions: quantization noise of about 6 dB per bit, peak to average (PAR) of the signal ˜14 dB, symbol SNR for a desired bit error rate (BER) and given constellation ˜22 dB, and a safety margin ˜6 dB. In total, at least seven bits are required, however, to be on the safe side, and according to the limitations of existing technology, it is recommended to use, without limiting the generality of the invention, a 10-bit or even 12-bit DAC.

Although the invention is described herein with reference to several embodiments, including the preferred embodiment, one skilled in the art will readily appreciate that other applications may be substituted for those set forth herein without departing from the spirit and scope of the invention. The invention may be further implemented in hardware, software, or any combination thereof. Accordingly, the invention should only be limited by the following Claims.

1. Apparatus for wireless transmission, comprising:
means for receiving uncompressed video signal components;
means for performing a de-correlating transform on said uncompressed video signal components to provide transform coefficients;
means for removing a portion of said transform coefficients;
means for separating remaining transform coefficients into a first group comprising low frequency coefficients and a second group comprising high frequency coefficients; and
means for mapping each of said remaining coefficients to a transmission symbol, said means for mapping further comprising means for separating said coefficients of said first group into a first value comprising most-significant bits of said coefficients and for mapping said most-significant bits to one of a plurality of constellation points of a transmission symbol, and into a second value comprising least-significant bits of said coefficients;
said transmission symbol carrying said first value further comprising a pilot symbol.

2. The apparatus of claim 1, said pilot symbol comprising a standard pilot symbol for wireless transmission.

3. The apparatus of claim 1, said wireless transmission comprising transmission of essentially uncompressed high-definition video.

4. The apparatus of claim 1, further comprising:
a sparsely populated constellation transmission scheme for sending said pilot symbol.

5. The apparatus of claim 4, said sparsely populated constellation transmission scheme comprising one of QPSK and 16-QAM.

6. A wireless communication system, comprising:
a transmitter comprising:
an input for receiving uncompressed components of a high definition video signal;
means for performing a de-correlating transform on said uncompressed components to produce transform coefficients;
means for removing a portion of said transform coefficients; and
means for mapping each of said remaining coefficients to a transmission symbol and for mapping at least a portion of said coefficients to a pilot symbol having a dual-function.

7. The wireless communication system of claim 6, further comprising:
a receiver for receiving a stream of symbols from said transmitter over a wireless link, for recreating said coefficients, and for receiving said dual-function pilot symbols.

8. The wireless communication system of claim 6, said wireless communication comprising transmission of essentially uncompressed high-definition video.

9. The wireless communication system of claim 6, said wireless communication comprising essentially delay-less transmission of said high-definition video signal.

10. The wireless communication system of claim 6, further comprising:
a sparsely populated constellation transmission scheme for transmitting said pilot symbol.

11. The wireless communication system of claim 10, said sparsely populated constellation transmission scheme comprising one of QPSK and 16-QAM.

12. The wireless communication system of claim 10, said the dual-function pilot comprising a pilot signal that does not have a predetermined value.

13. A communication method, comprising the steps of:
converting digital data to transmission symbols;
generating a sequence of pilot symbols;
placing said pilot symbols in predefined positions between said transmission symbols to produce an output stream of symbols, wherein at least one of said pilot symbols is a dual-function symbol that carries a portion of said digital data; and
transmitting the plurality of output stream of symbols over a wireless communication link.

14. The method of claim 13, further comprising:
receiving the output stream of symbols at a receiver;
using the pilot symbols for to establish a channel characteristics of a transmission channel;
identifying pilot symbols having a dual-function and extracting corresponding digital data from said dual-function pilot symbols; and
reconstructing said digital data from said transmission symbols.

15. The method of claim 13, said communication comprising transmission of essentially uncompressed high-definition video.

16. The method of claim 13, said communication system essentially a delay-less transmission of a high-definition video signal.

17. The method of claim 13, wherein the step of transmitting the plurality of output stream of symbols further comprising the step of:
sending said pilot symbols using a sparsely populated constellation transmission scheme.

18. The method of claim 17, said sparsely populated constellation transmission scheme comprising one of QPSK and 16-QAM.

19. The method of claim 13, said dual-function symbol comprising a pilot signal that does not have predetermined value.
